(19) United States
(12) Patent Application Publication
(10) Pub. No.: US 2014/0030408 A1
(43) Pub. Date: Jan. 30, 2014

(54) APPARATUS AND METHODS FOR PEELING GARLIC

(71) Applicant: Chef'n Corporation, Seattle, WA (US)

(72) Inventors: David A. Holcomb, Seattle, WA (US); Neil Seung Myung Vincenti, Seattle, WA (US)

(21) Appl. No.: 13/930,472

(22) Filed: Jun. 28, 2013

Related U.S. Application Data
(60) Provisional application No. 61/675,223, filed on Jul. 24, 2012.

(51) Int. Cl. A23N 7/00

(52) U.S. Cl. CPC A23N 7/00
USPC 426/482; 99/585

(57) ABSTRACT

A device for removing the husk from a clove of garlic incorporates female and male members. The female member has a body with a cylinder therein terminating in a resilient bottom with a compound surface relief. The male member has a handle and a rigid projection. The projection is sized and shaped to mate with the cylinder, to move longitudinally with respect to the cylinder, and to rotate about the longitudinal axis when positioned in the cylinder. The projection terminates in an end incorporating a resilient material having a compound surface relief. When a clove of garlic is placed in the device and the projection is inserted into the cylinder until the clove contacts the cylinder and the projection, rotation of the handle with respect to the female member removes the husk.

### BACKGROUND OF THE INVENTION

1. Field of the Invention

The present disclosure generally is related to kitchen tools, and more particularly, to tools for peeling garlic.

2. Description of the Related Art

Devices and methods for use in removing the husks from cloves of garlic can make peeling garlic and preparing food quicker, easier, cleaner and more enjoyable. A variety of devices have been developed over the years in an attempt to optimize this procedure.

### BRIEF SUMMARY OF THE INVENTION

The present disclosure is directed to devices and methods for use in removing the husk from cloves of garlic. In one particular embodiment, a device for use in removing the husk from a clove of garlic incorporates a female member and a male member. The female member has a body with a cylinder therein oriented about a longitudinal axis. A base of the cylinder incorporates a resilient material having a compound surface relief. The male member has a handle and a projection rigidly coupled thereto to move as a unit therewith. The projection is sized and shaped to mate with the cylinder in the female member, to move longitudinally with respect to the cylinder, and to rotate about the longitudinal axis when positioned in the cylinder. The projection terminates in a distal end incorporating a resilient material having a compound surface relief; whereby when at least one clove of garlic is placed in the cylinder and the projection is inserted into the cylinder until the clove is in contact with the cylinder and the projection, rotation of the handle with respect to the female member can remove husk from the clove of garlic.

### BRIEF DESCRIPTION OF THE SEVERAL VIEWS OF THE DRAWING(S)

FIG. 1 is a top perspective view of an apparatus for peeling garlic, according to one embodiment of the present invention.

FIG. 2 is a bottom perspective view of the apparatus of FIG. 1.

FIG. 3 is a top perspective view of a male member of the apparatus of FIG. 1.

FIG. 4 is a bottom perspective view of the male member of FIG. 3.

FIG. 5 is a top perspective view of a female member of the apparatus of FIG. 1.

FIG. 6 is another top perspective view of the female member of FIG. 5.

FIG. 7 is a diametric cross-sectional view of the apparatus of FIG. 1.

### DETAILED DESCRIPTION OF THE INVENTION

The following detailed description is directed toward apparatus and methods for peeling garlic and other, similar food items. The detailed description and corresponding figures are intended to provide an individual of ordinary skill in the art with enough information to enable that individual to make and use embodiments of the invention. Such an individual, however, having read this entire detailed description and reviewed the figures, will appreciate that modifications can be made to the illustrated and described embodiments, and/or elements removed therefrom, without deviating from the spirit of the invention. It is intended that all such modifications and deviations fall within the scope of the invention, and the invention is limited only by construction of following claims.

Reference throughout this specification to “one embodiment” or “an embodiment” means that a particular feature, structure or characteristic described in connection with the embodiment is included in at least one embodiment of the disclosed structures and/or methods. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

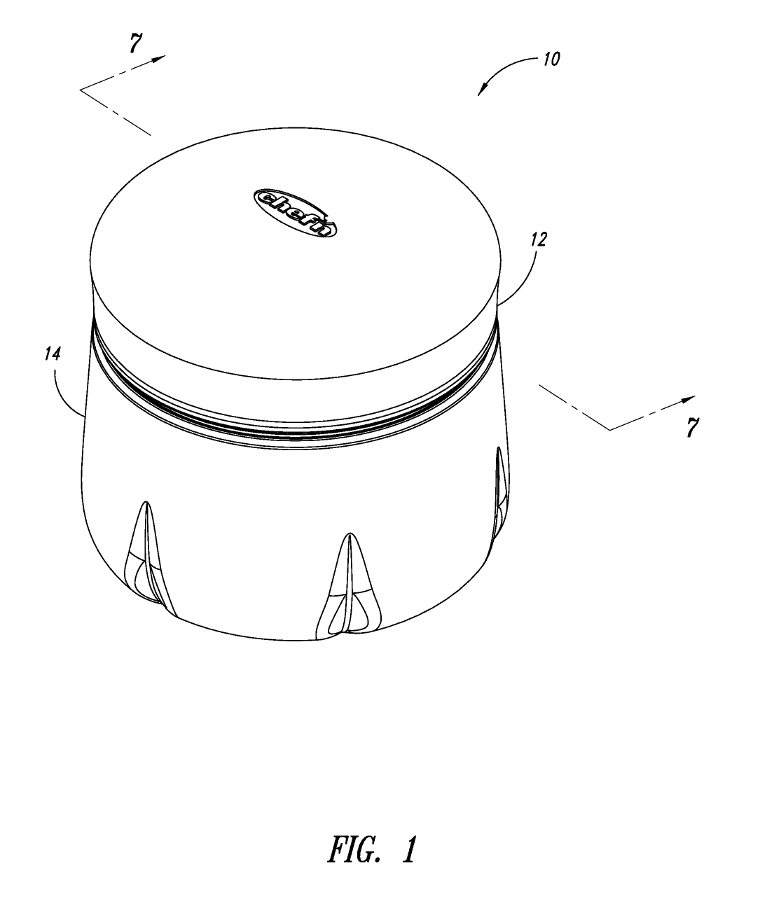

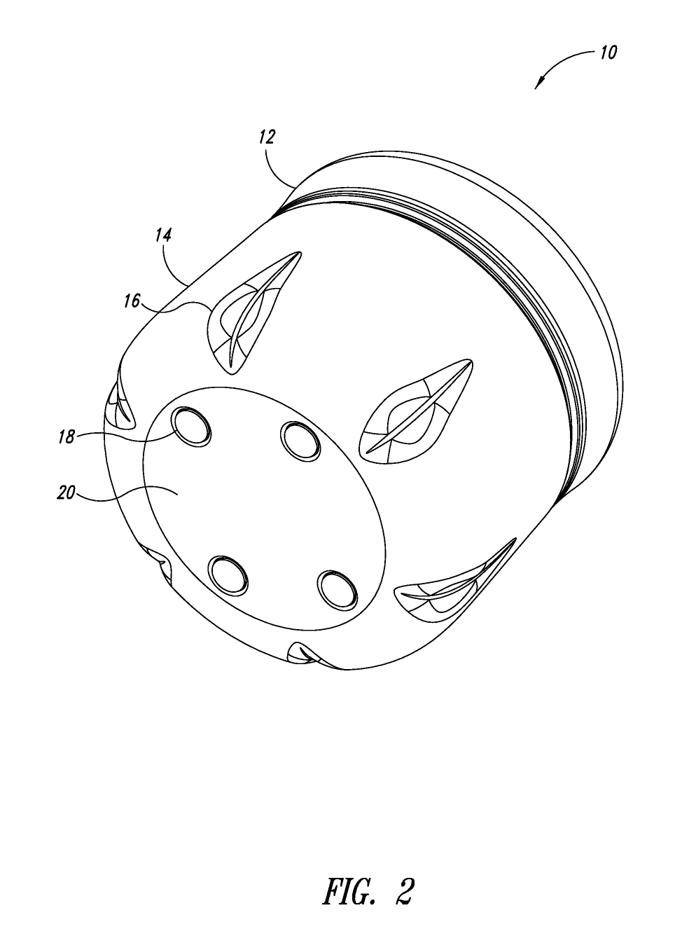

FIGS. 1 and 2 illustrate one particular embodiment of a device 10 for peeling garlic or similar food items. The illustrated device 10 primarily comprises an upper, male member 12 and a lower, female member 14. The device 10 can be sized and shaped to comfortably fit in a user's hand, and the user can use the device by holding the female member 14 in one hand and manipulating the male member 12 with the other hand. In the illustrated embodiment, the device 10 has a generally circular cross-section. In other embodiments, the outside shapes and dimensions of the device 10 can vary dramatically without deviating from the spirit of the invention. As noted below, only the interior shapes are particularly relevant.

As best illustrated in FIG. 2, the female member 14 can have depressions 16, contours or other features to facilitate gripping the female member during use, and/or it can have a coating, texture or otherwise be treated for such purposes. The male member 12 can be similarly adapted. The female member 14 also can have feet 18 or other features on its bottom surface 20 to resist slipping when the device 10 is manipulated while located on a countertop or other surface.

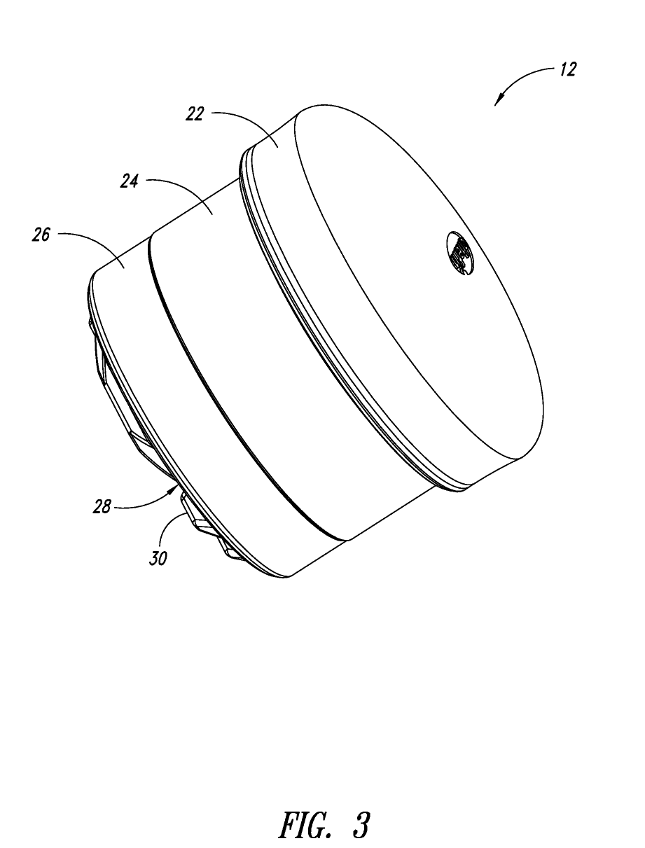

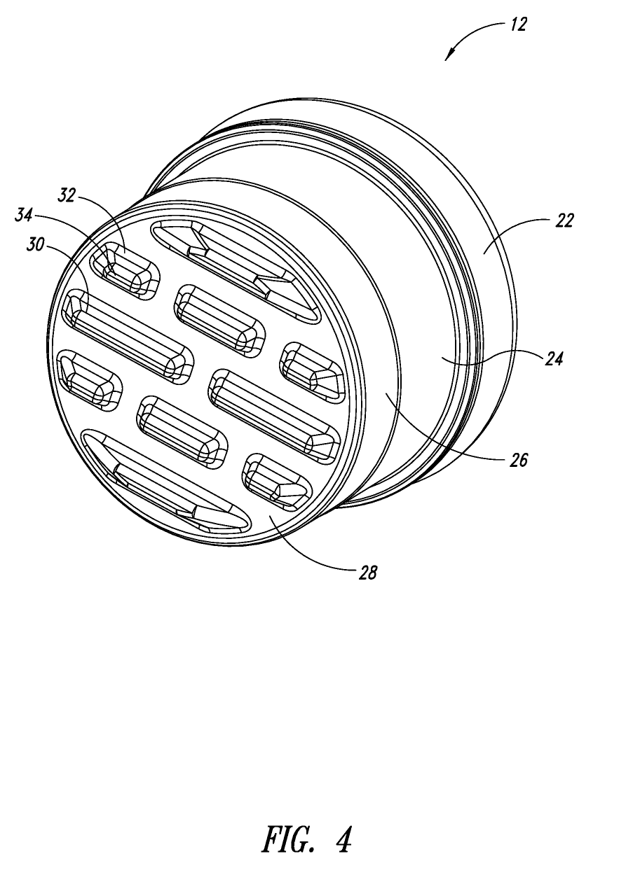

FIGS. 3 and 4 illustrate the male member 12 removed from the device 10. The illustrated upper portion 12 incorporates a handle 22 and a projection 24. The handle 22 can be sized, shaped and adapted to fit comfortably in a user's hand. The handle 22 can be circular, as shown, or can have another shape, as discussed above.

The projection 24 can be fixed to the handle 22, and projects therefrom for engagement with the female member 14. The projection 24 is adapted to rotate as a unit with the handle 22, such that when the user rotatingly reciprocates the handle during use, the projection 24 also rotatingly reciprocates.

In the illustrated embodiment, the projection 24 has a smaller diameter than the handle 22, although the size and shape of the handle 22 is not critical to the operation of the invention, as indicated above. The illustrated projection 24 is a right cylinder, symmetrical about a longitudinal axis of the device 10. The projection 24 could instead be conical or have another shape suitable for functioning as described herein. As discussed below, the projection 24 is complementary in size and shape with a mating feature on the female member 14.

The projection 24 on the male member 12 terminates opposite the handle 22 in a distal end 26. The illustrated distal end 26 is in the form of a cap coupled to the projection 24; however, the distal end could be an integral part of the projection or could take another form without deviating from the spirit of the invention. A bottom surface 28 of the distal end 26 of the projection 24 supports an array of fingers 30, which project outward from the bottom surface.

The fingers 30 in the illustrated embodiment are made from a resilient material (e.g., silicone, Shore A 45); however, other suitable materials could instead be used. In the illustrated embodiment, the fingers 30 are molded as a single part in combination with the cap that forms the distal end 26 of the projection 24. In other embodiments, the fingers 30 could be glued or otherwise attached, bonded, affixed or otherwise coupled to the bottom surface 28 of the projection 24, or could be formed through other suitable means.

As best illustrated in FIG. 4, the illustrated fingers 30 intersect the bottom surface 28 at a base curve 32, and terminate at their distal tips in an apex curve 34, giving the fingers a partially sinusoidal cross-section, although different shapes are also suitable. For example, the base curve 32 and/or apex curve 34 could be replaced by chamfered or otherwise formed. The fingers 30 can be flexible and resilient.

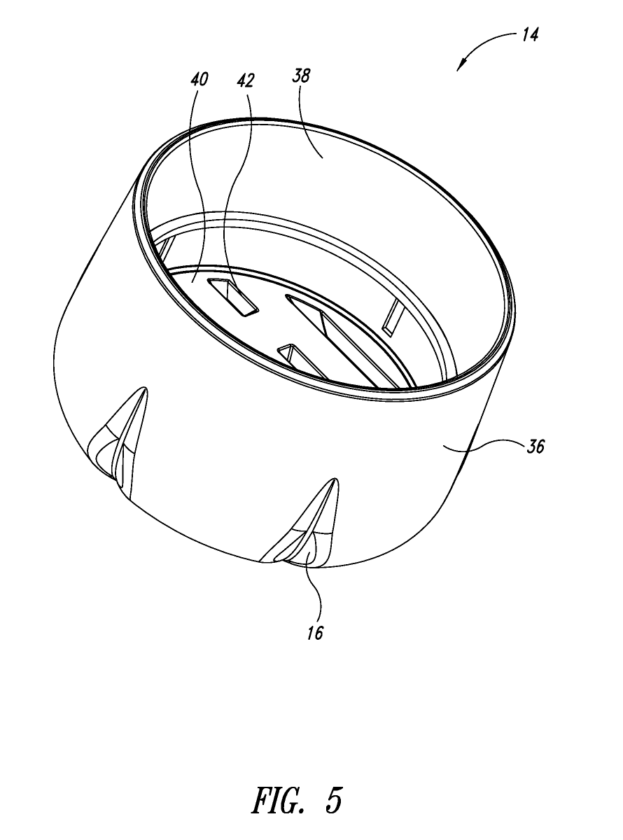

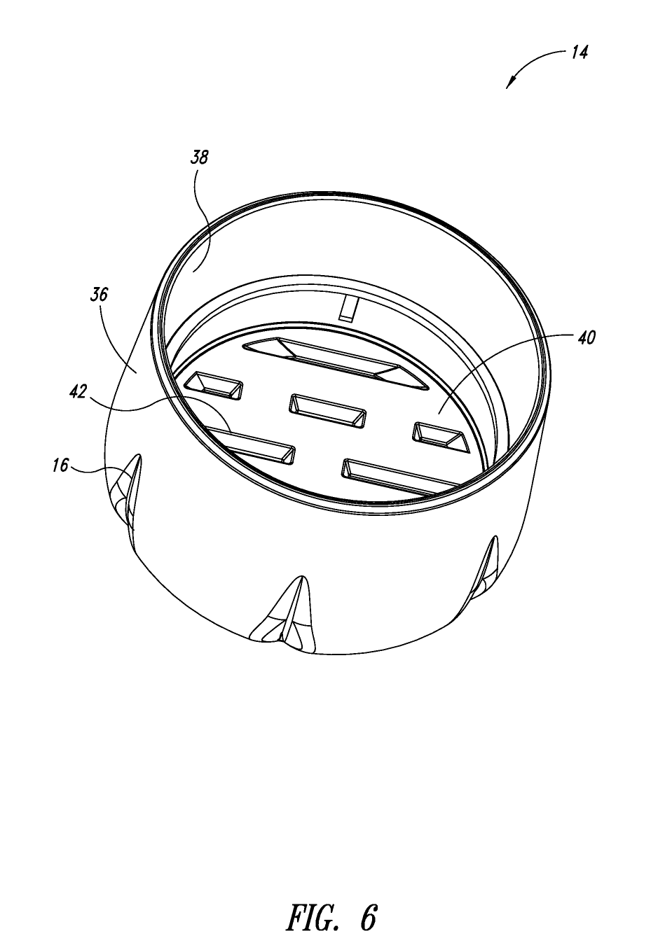

FIGS. 5 and 6 illustrate an embodiment of the female member 14. The female member 14 generally comprises a body 36 surrounding a cylinder 38. The body 36 of the female member 14 can be sized and shaped to fit within a user's hands, and can be adapted to rest on a countertop or other surface, similar to a countertop appliance.

The illustrated cylinder 38 is in the shape of a right cylinder, symmetrical about the longitudinal axis of the device 10, as is the projection 24 illustrated in association with this particular embodiment. As indicated above, the projection 24 and cylinder 38 could instead be conical or have other shapes that will function as described herein. The primary criterion is that the projection 24 can be received within and rotate with respect to the cylinder 38. The illustrated cylinder 38 has a diameter slightly larger than a corresponding diameter of the projection 24, allowing the projection to be received in the cylinder during use. The diameter of the cylinder 38 can be just slightly larger than that of the projection 24, or it can be even larger.

In alternate embodiments, the cylinder 38 and/or the projection 24 need not be a perfect cylinder; it is envisioned that other shapes and cross-sections could instead be used. Other shapes and combinations of shapes will suffice, provided the male member 12 can be received by the female member 14 and can be reciprocally rotated about the longitudinal axis over an angle sufficient to enable the device to peel garlic. As a non-limiting example, one or more stops or other features on the projection 24 and the cylinder 28 can be incorporated to allow the male member 2 to rotate with respect to the female member 14 over only 180 degrees, 90 degrees, or other ranges.

A bottom surface 40 at the base of the cylinder 38 contains an array of recesses 42 therein. The illustrated bottom surface 40 is flat and oriented substantially perpendicular to the longitudinal axis (as is the bottom surface 20 of the illustrated projection 24), although the surfaces need not be flat. As a non-limiting example, the surfaces could be partially spherical or partially conical, and can be complementary in shape, provided the surfaces, and the fingers 30 and recesses 42 satisfy their intended purpose during use. The bottom surface 40 and the recesses 42 in the illustrated embodiment are made from a resilient material (silicone, Shore A 45), although other suitable materials could also be used.

In alternate embodiments, fingers can be positioned on both the male and female components, or only on the female component, instead of the embodiment shown and described herein. Likewise, the recesses can be positioned on both the male and female components, or only the male component, instead of the embodiment shown herein. The only requirement is that the particular combination of fingers, recesses or both function as described herein to remove the husk from cloves of garlic.

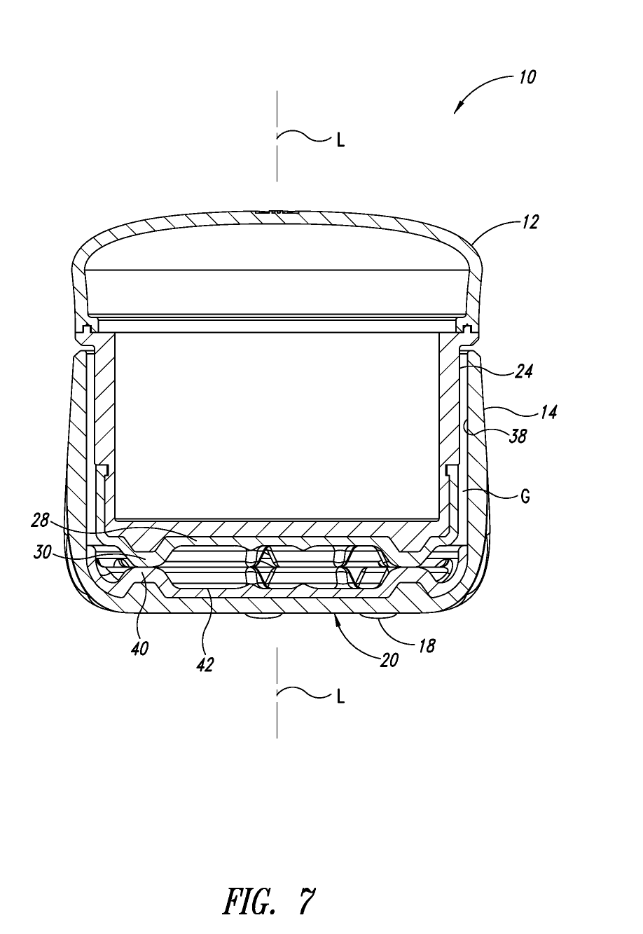

FIG. 7 is a cross-section further illustrating this particular embodiment of the invention. As depicted in FIG. 7, the male member 12 is fully inserted into the female member 14. In the illustrated embodiment, the fingers 30 contact the bottom surface 40 of the cylinder 38 at full engagement, although it is possible that the male member will “bottom out” before the fingers contact the bottom surface or will be spaced apart when the components are completely engaged. An individual of ordinary skill in the art, having reviewed this disclosure, will immediately appreciate the range of dimensions that are suitable.

As discussed above, the projection 24 and the cylinder 38 in the illustrated embodiment can be symmetrical about the longitudinal axis, L. The projection 24 has a diameter slightly smaller than that of the cylinder 38, creating a gap, G, therebetween. The projection 24 can slide longitudinally into and out of the cylinder 38, and can rotate with respect to the cylinder about the longitudinal axis L. As the projection is moved longitudinally with respect to the cylinder, the space between the fingers 30 and the bottom surface 40 increases and decreases. This longitudinal movement can compensate for the size and/or amount of garlic in the device 10. When the projection 24 is rotated with respect to the cylinder 38 about the longitudinal axis L, the fingers move with respect to the bottom surface 40 and the recesses 42. This lateral (circumferential) movement can force the garlic in the device 10 to rub against the edges of the fingers 30 and recesses 42, thereby removing the husk from the garlic.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A device for use in removing a husk from a clove of garlic, the device comprising:
a female member having a body with a cylinder therein oriented about a longitudinal axis, a base of the cylinder comprising a resilient material having a compound surface relief;
a male member having a handle and a projection rigidly coupled thereto to move as a unit therewith, the projection being sized and shaped to mate with the cylinder in the female member, to move longitudinally with respect to the cylinder, and to rotate about the longitudinal axis when positioned in the cylinder, the projection terminating in a distal end, the distal end comprising a resilient material having a compound surface relief; whereby
when at least one clove of garlic is placed in the cylinder and the projection is inserted into the cylinder until the clove is in contact with the cylinder and the projection, rotation of the handle with respect to the female member can remove husk from the clove of garlic.

2. The device of claim 1 wherein the cylinder in the female member is a right cylinder.

3. The device of claim 1 wherein the wall of the cylinder is cylindrical.

4. The device of claim 1 wherein the wall of the cylinder is smooth.

5. The device of claim 1 wherein the projection is a right cylinder.

6. The device of claim 1 wherein a wall of the projection is cylindrical.

7. The device of claim 1 wherein a wall of the projection is smooth.

8. The device of claim 1 wherein the cylinder and the projection have the same cross-sectional shape.

9. The device of claim 1 wherein surface relief on the bottom of the cylinder comprises a plurality of recesses.

10. The device of claim 1 wherein the surface relief on the end of the projection comprises a plurality of fingers.

11. A method of removing a husk from a clove of garlic, the method comprising placing the clove in a cylinder in a body of a female member, inserting a projection on a male member into the cylinder until the projection contacts the clove, and rotating a handle on the male member with respect to the female member to cause the projection to rotate within the cylinder, thereby removing the husk from the clove.
